(19) United States
(12) Patent Application Publication
(10) Pub. No.: US 2003/0033303 A1
(43) Pub. Date: Feb. 13, 2003

(54) System and method for restricting access to secured data

(76) Inventor: Brian Collins, New Malden (GB)

Correspondence Address: ERIC B. MEYERTONS, CONLEY, ROSE & TAYON, P.C., P.O. BOX 398, AUSTIN, TX, 78767-0398, US

(21) Appl. No.: 10/200,016

(22) Filed: Jul. 19, 2002

Related U.S. Application Data
(60) Provisional application No. 60/310,550, filed on Aug. 7, 2001.

(51) Int. Cl. G06F 15/16; G06F 17/30; G06F 7/00

(52) U.S. Cl. 707/9; 709/217

(57) ABSTRACT

A system and method for restricting the use of secure data on a computer system are provided. An interception program may be added as part of an interface program. The interception program may control access to the content of storage media such as an extension to the file system program of the operating system of the computer system. The secured data may be encrypted, and requested data may be decrypted by the interception program before it is returned. If the intercepted file system access operation is to open the secured data, but does not originate from an application program including executable program code stored within the secured data, the file system access operation may fail. In addition, an error message may be displayed implying that the user does not have sufficient privilege to access the requested data.

### PRIORITY CLAIM

This application claims the benefit of U.S. Provisional Patent Applications serial No. 60/310,550 to Brian Collins entitled “SYSTEM AND METHOD FOR RESTRICTING ACCESS TO SECURED DATA” filed Aug. 7, 2001.

### BACKGROUND OF THE INVENTION

1. Field of the Invention

The present invention generally relates to systems and methods for securing data stored on computer media. Certain embodiments relate to systems and methods for restricting access to secured data stored on computer media.

2. Description of the Related Art

Sensitive data is frequently distributed to remote users. It is common to encrypt such data as it is stored on computer media by an identifying method such as requiring the use of a password before the data may be accessed.

Many existing methods may be used to decrypt the data into a “clear” form, which may be understood by human readers or processed by appropriate application programs. One common example is to allow the user to explicitly decrypt the data into a clear copy on a storage media from which it may be read or processed. Alternatively, a special-purpose application program may be written that may be able to decrypt, read and process the data. Another example is to add a decryption program as part of an interface program provided for accessing the content of the storage media such as an extension to the file system program of the operating system of the computer system. In this manner, when the decryption program is enabled (commonly by entry of a password), any application program accessing the encrypted storage media would be able to read the decrypted contents, but no decrypted clear copy need be stored persistently.

Each of these existing methods, however, may have some disadvantages. For example, if a user explicitly decrypts data into a clear form, then that decrypted copy may be insecure thereby allowing access from any applications and potentially by other users of the computer system. Generally, a special-purpose application which may decrypt the data as it is read, is relatively secure. Such a special-purpose computer program, however, may be very expensive to produce, and the intended effect may be achieved in a more cost-effective manner by an existing “off-the-shelf” application program if it were allowed access to secured data. If such a decryption program is part of the file system program of a computer system, then although a decrypted copy of the data may not be stored on the media for the duration that the decryption is enabled any application program may access the data. A disadvantage of such a program arises when the originator of the secured data does not trust the users to whom the data has been distributed. Therefore, it may often be a requirement that the secured data may be accessed only by designated application programs and may not, for example, be copied in decrypted form to any other storage media.

Accordingly, it may be advantageous to allow access to secure encrypted data by designated, trusted application programs that do not allow the decrypted data to be accessed from any other application programs or to be copied in decrypted form to any other storage media.

### SUMMARY OF THE INVENTION

An embodiment of the invention relates to systems and methods for restricting the use of sensitive information. The method may include adding an interception program as part of an interface program. The interception program may control access to the content of storage media such as an extension to the file system program of the operating system of the computer system. The method may also include identifying to the interception program a set of files that include the secured data. In addition, the method may include for each intercepted file system access, identifying whether the access operation originates from an application program whose executable program code is also stored within the secured data (an “authorized application”). The secured data may be encrypted, and requested data may be decrypted by the interception program before it is returned. Without the use of encryption, the secured data may be accessed in an uncontrolled manner by removal of the interception program. Alternatively, sensitive elements of the secured data may be encrypted, but authorized applications may not be encrypted if access to the secured data may be constrained by the interception program to be read-only. If the intercepted file system access operation is to open the secured data but does not originate from an application program whose executable program code is also stored within the secured data, the file system access operation may fail in a manner that may cause the application program to display an error message. The error message may be configured to imply that the user did not have sufficient privilege to access the requested data.

By this method, application programs that may access the secured data include application programs stored within the secured data itself. Such application programs may be provided and/or stored by the originator of the secured data. The originator may, therefore, enforce any access controls that the originator sees fit. For example, the application programs stored within the secured data may not allow the data to be copied onto other storage media (e.g., via a “Save” action) or to be printed.

### BRIEF DESCRIPTION OF THE DRAWINGS

Other objects and advantages of the invention will become apparent upon reading the following detailed description and upon reference to the accompanying drawings in which:

FIG. 1 is a network diagram of an embodiment of a wide area network that may be suitable for implementing various embodiments;

FIG. 2 is an illustration of an embodiment of a computer system that may be suitable for implementing various embodiments; and

FIG. 3 is a flowchart of an embodiment of a system and method for restricting access to secured data on computer media.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

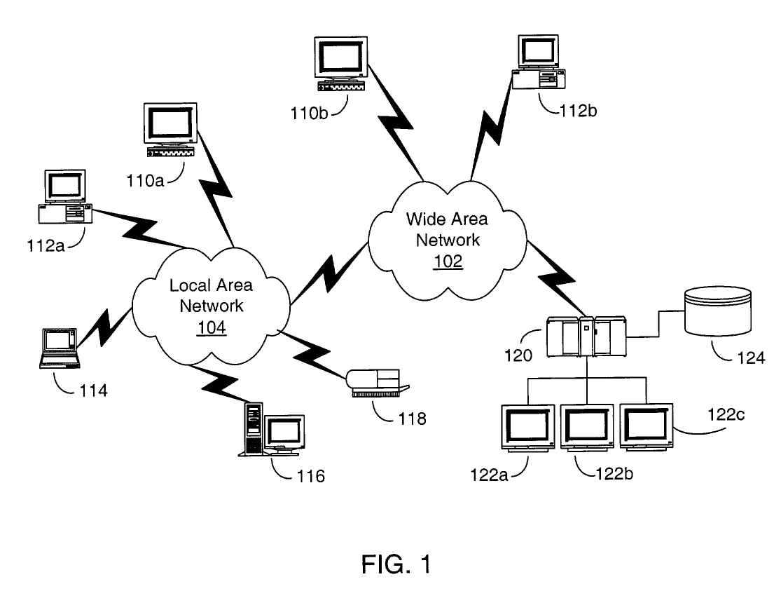

FIG. 1 illustrates a wide area network (“WAN”) according to one embodiment. WAN 102 may be a network that spans a relatively large geographical area. The Internet is an example of a WAN. WAN 102 typically includes a plurality of computer systems that may be interconnected through one or more networks. Although one particular configuration is shown in FIG. 1, WAN 102 may include a variety of heterogeneous computer systems and networks that may be interconnected in a variety of ways and that may run a variety of software applications.

One or more local area networks (“LANs”) 104 may be coupled to WAN 102. LAN 104 may be a network that spans a relatively small area. Typically, LAN 104 may be confined to a single building or group of buildings. Each node (i.e., individual computer system or device) on LAN 104 may have its own CPU with which it may execute programs, and each node may also be able to access data and devices anywhere on LAN 104. LAN 104, thus, may allow many users to share devices (e.g., printers) and data stored on file servers. LAN 104 may be characterized by a variety of types of topology (i.e., the geometric arrangement of devices on the network), of protocols (i.e., the rules and encoding specifications for sending data and whether the network uses a peer-to-peer or client/server architecture), and of media (e.g., twisted-pair wire, coaxial cables, fiber optic cables, and/or radio waves).

Each LAN 104 may include a plurality of interconnected computer systems and optionally one or more other devices such as one or more workstations 110a, one or more personal computers 112a, one or more laptop or notebook computer systems 114, one or more server computer systems 116, and one or more network printers 118. As illustrated in FIG. 1, an example LAN 104 may include one of each computer systems 110a, 112a, 114, and 116, and one printer 118. LAN 104 may be coupled to other computer systems and/or other devices and/or other LANs 104 through WAN 102.

One or more mainframe computer systems 120 may be coupled to WAN 102. As shown, mainframe 120 may be coupled to a storage device or file server 124 and mainframe terminals 122a, 122b, and 122c. Mainframe terminals 122a, 122b, and 122c may access data stored in the storage device or file server 124 coupled to or included in mainframe computer system 120.

WAN 102 may also include computer systems connected to WAN 102 individually and not through LAN 104 such as for purposes of example, workstation 110b and personal computer 112b. For example, WAN 102 may include computer systems that may be geographically remote and connected to each other through the Internet.

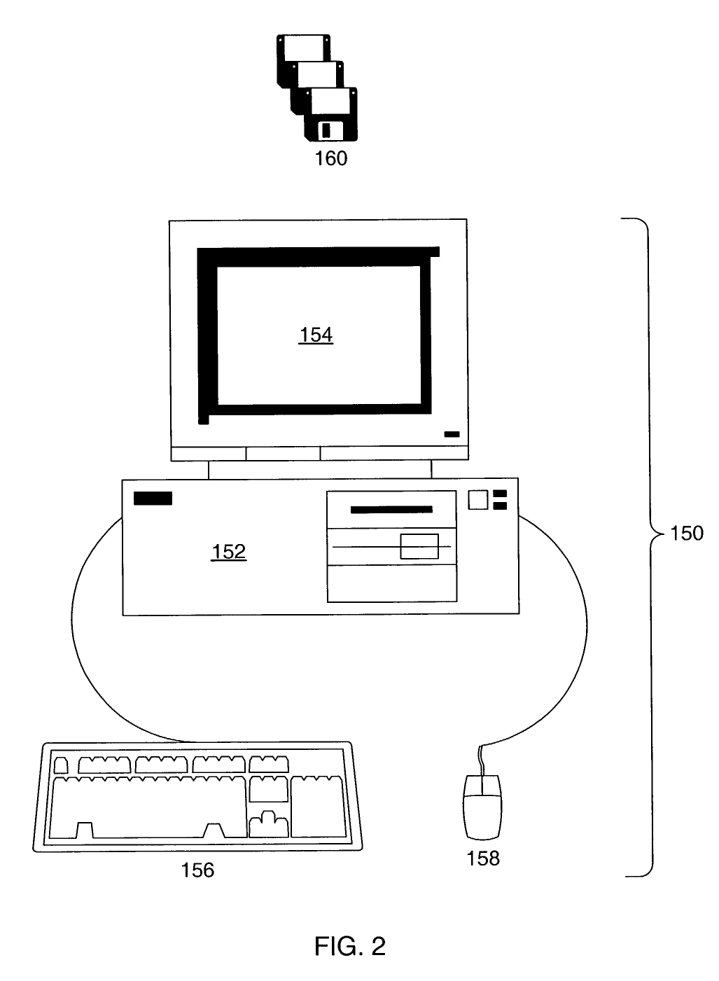

FIG. 2 illustrates an embodiment of computer system 150 that may be suitable for implementing various embodiments of a system and method for restricting the use of secure information. Each computer system 150 typically includes components such as CPU 152 with an associated memory medium such as floppy disks 160. The memory medium may store program instructions for computer programs. The program instructions may be executable by CPU 152. Computer system 150 may further include a display device such as monitor 154, an alphanumeric input device such as keyboard 156, and a directional input device such as mouse 158. Computer system 150 may be operable to execute the computer programs to implement a method for restricting the use of secure information as described herein.

Computer system 150 may include memory medium on which computer programs according to various embodiments may be stored. The term “memory medium” is intended to include an installation medium, e.g., a CD-ROM, or floppy disks 160, a computer system memory such as DRAM, SRAM, EDO RAM, Rambus RAM, etc., or a non-volatile memory such as a magnetic media, e.g., a hard drive or optical storage. The memory medium may also include other types of memory or combinations thereof. In addition, the memory medium may be located in a first computer which executes the programs or may be located in a second different computer which connects to the first computer over a network. In the latter instance, the second computer may provide the program instructions to the first computer for execution. Also, computer system 150 may take various forms such as a personal computer system, mainframe computer system, workstation, network appliance, Internet appliance, personal digital assistant (“PDA”), television system or other device. In general, the term “computer system” generally refers to any device having a processor which executes instructions from a memory medium.

The memory medium may store a software program or programs operable to implement a method for restricting the use of secure information as described herein. The software program(s) may be implemented in various ways, including, but not limited to, procedure-based techniques, component-based techniques, and/or object-oriented techniques, among others. For example, the software program(s) may be implemented using ActiveX controls, C++ objects, JavaBeans, Microsoft Foundation Classes (“MFC”), browser-based applications (e.g., Java applets), traditional programs, or other technologies or methodologies, as desired. A CPU such as host CPU 152 executing code and data from the memory medium may include a means for creating and executing the software program or programs according to the methods and/or block diagrams described herein.

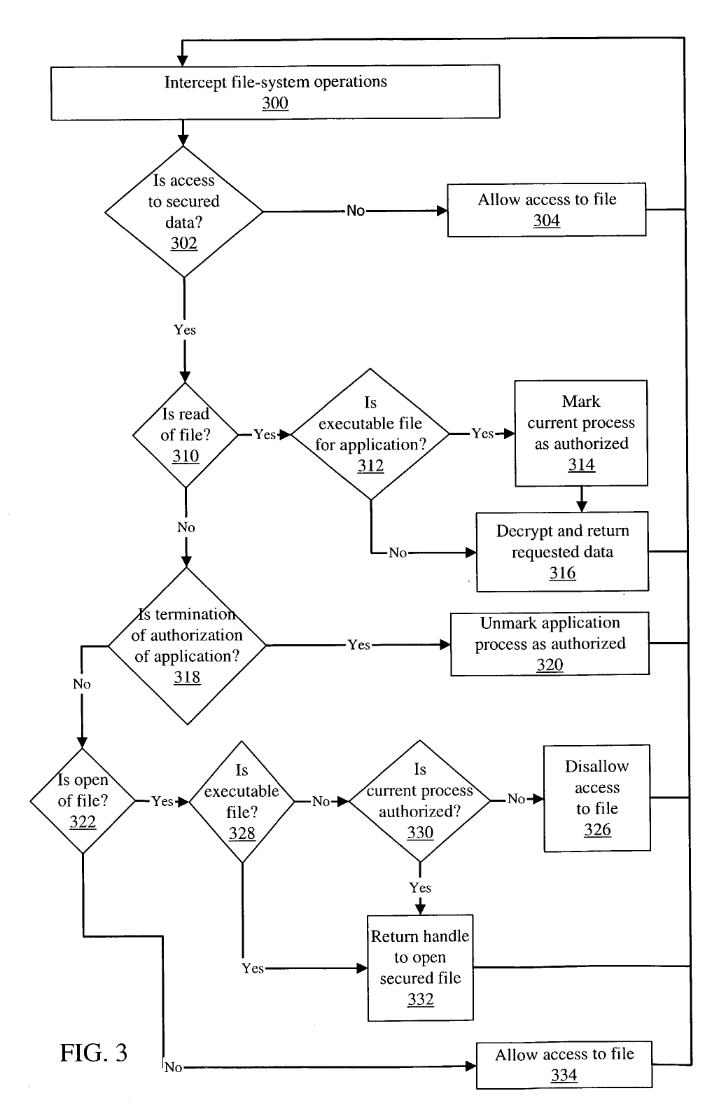

FIG. 3 illustrates an embodiment of a system and method for restricting access to secured data on computer media. As used herein, “secured data” generally refers to files identified by a user to be protected. In various embodiments, the user may use any known method to identify secured data.

In an embodiment, an interception program may be provided as part of an interface program. The interception program may access content of storage media as an extension to a file system program of an operating system of a computer system. As used herein, an “extension” to a file system program generally refers to an addition to the file system program configured to allow certain actions to be taken. For example, the interception program may detect the termination of running application programs. The interception program may be coupled to the operating system of the computer system in which a copy of the original file system hierarchy is stored. The operating system may be modified to detect attempts to access files within the file system hierarchy, as shown in step 300. In an embodiment, an intercepted file system operation (e.g., an attempt to access a file) may be identified by the interception program as originating from a particular process. An intercepted file system operation may be examined and acted upon as described herein.

As shown in step 302, the method may include determining if an intercepted file system operation includes a request to access secured data. If the intercepted file system operation does not include a request to access secured data, the method may allowing access to the requested as shown in step 304. If the intercepted file system operation includes a request to access secured data, the method may include step 310.

At step 310, the method may include determining if the file system operation includes a read operation to read the contents of a file within the secured data. If the file system operation includes a read operation, then the method may include step 312. If the file system operation does not include a read operation, then the method may include step 318.

At step 312, the method may include determining if the file system operation includes a request to access an executable file. As used herein, an “executable file” generally refers to a computer program file and/or a file including a command (e.g., a “copy” command). An executable file may possesses properties common to other files, in that an executable file may resides somewhere in the file system. For example, the executable file may reside in a standard directory in the file system (e.g., where other utility commands generally reside), in any other directory in the file system, or within a directory located in a “secure” area of the file system (e.g., in the secured data).

If the file system operation includes a request to access an executable file, then the current process may be marked as authorized for the purpose of further access to secure data, as shown in step 314. As used herein, a “process” refers to a set of acts identified by an operating system as related to one another. Methods of identifying processes are known in the art. For example, an identified process may read an executable file into memory and then read from a data file using the executable file. In such a case, the process may initiate and/or access several executable files. Additionally, the process may access one or more data files. In this manner, requests to access secured files may originate from identified processes. Such access may be allowed if the identified process has been marked as “authorized”.

An operating system of a computer system may provide a method for determining if the read operation is in order to load the executable code for the application. One such method known in the art, may keep files open only for the duration of their use, may include determining that read accesses to executable code are in order to load the executable code for the application. In addition, the method may include terminating the application when the executable code file is closed. Another such method known in the art, may keep executable code files open for a duration that exceeds the life of the running application program. It is noted that step 316 may be processed after step 314 and may also be processed for the “No” path for decision step 312. As shown in step 316, the interception program may decrypt the requested data block (provided the secured data was encrypted). The interception program may also return the data in response to the read operation.

As shown in step 318, the method may include determining if the file system operation includes an indication of the termination of authorization of the application. If the operation includes termination of the authorization of the application, then the computer operating system process for that application may be unmarked as being authorized, as shown in step 320. Termination of authorization of the application may be indicated by either a closure of an executable file or an explicit notification of termination of the application from the computer operating system. If the operation is not an indication of the termination of authorization of the application, then the method may include step 322.

As shown in step 322, the method may include determining if the file system operation includes an open operation. If the file system operation includes an open operation, then the method may include step 328. If the file system operation does not include an open operation, the method may include allowing the file system operation to processed, as shown in step 334.

As shown in step 328, the method may include determining if a file to be opened is an executable file. If the file to be opened is an executable file, then the interception program may construct and return an open file handle that identifies the file, as shown in step 332. The open file handle may identify the file for subsequent file read operations. If the file to be opened includes a file other than an executable file, then the method may include step 330.

At 330, the method may include determining if the current process is marked as being authorized. If the current process is marked as being authorized, then the interception program may construct and return an open file handle that identifies the file, as shown in step 332. The open file handle may identify the file for subsequent file read operations. If the current process is not marked as being authorized, then the method may include inhibiting access to the file as shown in step 326.

In an embodiment, the method may inhibit writing to any file by executable programs that reside within the secured data. For example, a publisher who produces a very expensive training course on CD-ROM and uses a particular format and an off-the-shelf viewer program to display the course may wish to disallow saving of the secured data to protect the publisher's investment in the course. Using methods described herein, the publisher may add a version of the viewer that may not allow printing or saving. In this alternative embodiment, the added version of the viewer may not be required as the authorized process. By running an unmodified off-the-shelf program, a user accessing the secured data may not be able to write the secured data to an unsecured storage area or to a printer.

In an additional embodiment, the method may include allowing the secured data to be stored on digitally signed storage media. As used herein, “digitally signed storage media” generally refers to any recording media such as a hard disk or CD-ROM that includes a ‘digital signature’. The digital signature may be used to uniquely identify the media and may typically be used to prevent the media from being physically copied. The most common form of digitally signed media is a CD-ROM with a digital signature, which may not be copied by CD recorders or mastering equipment. The digital signature may be embedded by a laser beam recorder when the CD-ROM master is made by mastering/replication. Such a digital signature may be easily read by computer programs reading from the CD-ROM. In this embodiment, the encryption key used in decryption step 316 may be derived from a number of inputs (such as passwords) including the digital signature. If the signature cannot be read from the digitally signed storage media, or does not match that used when the data was originally encrypted, then the secured data may not be read. As such, the method may prevent access to secured data copied onto different media.

### EXAMPLES

The following examples refer to various steps, of a method for restricting access to secured data stored on computer media, as shown in FIG. 3. These examples are written in pseudo-code for purposes of indicating that the method may apply to any computer operating system.

### Example #1

Open secure_data_file using secure_executable_file

“secure_executable_file” refers to the name of an executable file in the secured data area of a file system or, alternatively, to a directory path to the executable file. Similarly, “secure_data_file” refers to the name of a data file in the secured data area of a file system or, alternatively, to a directory path to the data file. The open of the “secure_executable_file” is intercepted in step 300. Step 302 yields a “yes” answer to the query: is access to secured data? Step 310 yields a “yes” answer to the query: is read of file? Step 312 yields a “yes” answer to the query: is executable file for the application? The current process is marked as authorized in step 314. The requested data (“secure_executable_file”) is decrypted and returned. Processing loops back to step 300. The current process starts to execute the “secure_executable_file” which is now in memory, and the “secure executable file” in turn attempts to open the “secure_data_file”. The open of the “secure_data_file” is intercepted in step 300. Step 302 yields a “yes” answer to the query: is access to secured data? Step 310 yields a “no” answer to the query: is read of file? Step 318 yields a “no” answer to the query: is termination of authorized application? Step 322 yields a “yes” answer to the query: is open of file? Step 328 yields a “no” answer to the query: is executable file? Step 330 yields a “yes” answer to the query: is current process authorized? In step 332, the handle to open the requested file (“secure_data_file”) is returned. Processing loops back to step 300. Processing of the “secure_executable_file” completes and is intercepted in step 300. Step 302 yields a “yes” answer to the query: is access to secured data? Step 310 yields a “no” answer to the query: is read of file? Step 318 yields a “yes” answer to the query: is termination of authorized application? The current process is unmarked as authorized in step 320. Processing loops back to step 300.

### EXAMPLE #2

copy_command secure_file_to_be_copied insecure_file_destination

“copy command” refers to a method provided by the operating system to copy files. “secure_file_to_be_copied” refers to the name of a file in the secured data area of the file system or, alternatively, a directory path to the file. Similarly, “insecure_file_destination” refers to the name of a destination file outside of the secured data area of the file system, the name of a destination directory outside of the secured data area of the file system, or a directory path to the destination file or the destination directory. The open of the “copy_command” is intercepted in step 300. Step 302 yields a “no” answer to the query: is access to secured data? Access is allowed to the file (“copy_command”) in step 304. Processing loops back to step 300. The current process starts to execute the “copy_command”, which is now in memory, and the “copy command” in turn attempts to open the “secure_file_to_be_copied”. The open of the “secure_file_to_be-copied” is intercepted in step 300. Step 302 yields a “yes” answer to the query: is access to secured data? Step 310 yields a “no” answer to the query: is read of file? Step 318 yields a “no” answer to the query: is termination of authorized application? Step 322 yields a “yes” answer to the query: is open of file? Step 328 yields a “no” answer to the query: is executable file? Step 330 yields a “no” answer to the query: is current process authorized? Access is disallowed to the file (“secure_file_to_be_copied”) in step 326. Processing loops back to step 300. Processing of the “copy_command” completes and is intercepted in step 300. Step 302 yields a “no” answer to the query: is access to secured data? Access is allowed to the file (“copy_command”) in step 304. Processing loops back to step 300.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method of restricting access to secured data on a computer system comprising:
intercepting a file system operation seeking access to secured data; and
determining if the intercepted file system operation originated from an application program comprising executable program code stored within the secured data.

2. A method, comprising:
providing a set of files identified as secured data;
providing an interception program coupled to an operating system of the computer system, wherein the interception program is configured to control access to a memory medium containing the secured data; and
intercepting file system operations with the interception program.

3. The method of claim 2, wherein a file system operation comprises an application termination operations.

4. The method of claim 2, wherein the interception program comprises an extension to a file system program of the operating system.

5. The method of claim 2, further comprising:
determining if an intercepted file system operation is allowed to access the secured data; and
determining if the operation originates from an application program comprising executable program code stored within the secured data.

6. The method of claim 5, further comprising determining if the file system operation is allowed to read from the secured data.

7. The method of claim 5, further comprising determining if the operation is allowed to open the secured data.

8. The method of claim 5, further comprising inhibiting processing of the file system operation if the operation does not originate from the application program comprising program code stored within the secured data.

9. The method of claim 5, further comprising monitoring processes of the application program for execution and termination.

10. The method of claim 5, further comprising monitoring processes of the application program within the operating system for open executable program code files within the secured data.

11. The method of claim 5, further comprising, if the intercepted file system operation originated from an application program comprising executable program code stored within the secured data:
reading from the secured data,
decrypting the secured data; and
returning the secured data to the application program.

12. The method of claim 11, wherein decrypting the data comprises using specific values from a digital signature on a secured storage media, and wherein the digital signature is inhibited from being copied whenever the media is copied.

13. The method of claim 11, wherein the secured data comprises an executable file, and wherein the method further comprises marking a current process as authorized such that the current process can further access the secured data.

14. The method of claim 13, wherein, if the file system operation comprises an indication of the termination of authorization of the application program, the method further comprises:
unmarking the current process as authorized to deny further access by the process to the secured data.

15. The method of claim 5, wherein, if an intercepted file system operation originated from an application program comprising executable program code stored within the secured data, the method further comprises inhibiting writing to the secured data by the application program.

16. The method of claim 5, wherein, if the file system operation comprises a request to access an executable file, the method further comprises:
constructing an open file handle that identifies the executable file; and
returning the open file handle to the application program.

17. The method of claim 5, wherein, if the file system operation includes a request to open secured data that does not include an executable file, the method further comprises:
determining if a current process is marked as authorized such that the current process can further access the secured data.

18. The method of claim 17, further comprising inhibiting opening of the secured data if the current process is not marked as authorized.

19. The method of claim 17, wherein, if the current process is marked as authorized, the method further comprises:
constructing an open file handle that identifies the secured data; and
returning the open file handle to the application program.

20. A system configured to restrict access to secured data on a computer system, comprising:
a CPU; and
a system memory coupled to the CPU, wherein the system memory stores one or more computer programs executable by the CPU;
wherein one or more computer programs are executable to:
intercept a file system operation seeking access to secured data; and
determine if the intercepted file system operation originated from an application program comprising executable program code stored within the secured data.

21. A system configured to restrict access to secured data on a computer system, comprising:
a CPU; and
a system memory coupled to the CPU, wherein the system memory stores one or more computer programs executable by the CPU;
wherein one or more computer programs are executable to:
identify a set of files as secured data;
intercept file system access operations with an interception program, wherein the interception program is coupled to an operating system of the computer system, and wherein the interception program controls access to a memory medium containing the secured data.

22. The system of claim 21, wherein the one or more computer programs are further executable to intercept application termination operations.

23. The system of claim 21, wherein the interception program comprises an extension to a file system program of the operating system.

24. The system of claim 21, wherein the one or more computer programs are further executable to:
determine if an intercepted file system operation is allowed to access the secured data; and
determine if the operation originates from an application program comprising executable program code stored within the secured data.

25. The system of claim 24, wherein the one or more computer programs are further executable to determine if the file system operation is allowed to read from the secured data.

26. The system of claim 24, wherein the one or more computer programs are further executable to determine if the operation is allowed to open the secured data.

27. The system of claim 24, wherein the one or more computer programs are further executable to inhibit processing of the file system operation if the operation does not originate from the application program comprising program code stored within the secured data.

28. The system of claim 24, wherein the one or more computer programs are further executable to:
monitor processes of the application program for execution and termination.

29. The system of claim 24, wherein the one or more computer programs are further executable to:
monitor processes of the application program within the operating system for open executable program code files within the secured data

30. The system of claim 24, wherein, if the intercepted file system operation originated from an application program comprising executable program code stored within the secured data, the one or more computer programs are further executable to:
read from the secured data,
decrypt the secured data; and
return the secured data to the application program.

31. The system of claim 30, wherein decrypting the data comprises using specific values from a digital signature on a secured storage media, and wherein the digital signature is inhibited from being copied whenever the media is copied.

32. The system of claim 30, wherein the secured data comprises an executable file, and wherein the one or more computer programs are further executable to mark a current process as authorized such that the current process can further access the secured data.

33. The system of claim 31, wherein, if the file system operation comprises an indication of the termination of authorization of the application program, the one or more computer programs are further executable to:
unmark the current process as authorized to deny further access by the process to the secured data.

34. The system of claim 24, wherein, if an intercepted file system operation originated from an application program comprising executable program code stored within the secured data, the one or more computer programs are further executable to inhibit writing to the secured data by the application program.

35. The system of claim 24, wherein, if the file system operation comprises a request to access an executable file, the one or more computer programs are further executable to:
construct an open file handle that identifies the executable file; and
return the open file handle to the application program.

36. The system of claim 24, wherein, if the file system operation includes a request to open secured data that does not include an executable file, the one or more computer programs are further executable to:
determine if a current process is marked as authorized such that the current process can further access the secured data.

37. The system of claim 36, wherein the one or more computer programs are further executable to inhibit opening of the secured data if the current process is not marked as authorized.

38. The system of claim 36, wherein, if the current process is marked as authorized, the one or more computer programs are further executable to:
construct an open file handle that identifies the secured data; and
return the open file handle to the application program.

39. A carrier medium configured to store program instructions, wherein the program instructions are executable to implement a method, comprising:
intercepting a file system operation seeking access to secured data; and
determining if the intercepted file system operation originated from an application program comprising executable program code stored within the secured data.

40. A carrier medium configured to store program instructions, wherein the program instructions are executable to implement a method, comprising:
providing a set of files identified as secured data;
providing an interception program coupled to an operating system of the computer system, wherein the interception program is configured to control access to a memory medium containing the secured data; and
intercepting file system operations with the interception program.

41. The carrier medium of claim 40, wherein a file system operation comprises an application termination operations.

42. The carrier medium of claim 40, wherein the interception program comprises an extension to a file system program of the operating system.

43. The carrier medium of claim 40, wherein the method further comprises:
determining if an intercepted file system operation is allowed to access the secured data; and
determining if the operation originates from an application program comprising executable program code stored within the secured data.

44. The carrier medium of claim 43, wherein the method further comprises determining if the file system operation is allowed to read from the secured data. The carrier medium of claim 43, wherein the method further comprises determining if the operation is allowed to open the secured data.

45. The carrier medium of claim 43, wherein the method further comprises inhibiting processing of the file system operation if the operation does not originate from the application program comprising program code stored within the secured data.

46. The carrier medium of claim 43, wherein the method further comprises monitoring processes of the application program for execution and termination.

47. The carrier medium of claim 43, wherein the method further comprises monitoring processes of the application program within the operating system for open executable program code files within the secured data.

48. The carrier medium of claim 43, wherein the method further comprises, if the intercepted file system operation originated from an application program comprising executable program code stored within the secured data:
reading from the secured data,
decrypting the secured data; and
returning the secured data to the application program.

49. The carrier medium of claim 48, wherein decrypting the data comprises using specific values from a digital signature on a secured storage media, and wherein the digital signature is inhibited from being copied whenever the media is copied.

50. The carrier medium of claim 48, wherein the secured data comprises an executable file, and wherein the method further comprises marking a current process as authorized such that the current process can further access the secured data.

51. The carrier medium of claim 50, wherein, if the file system operation comprises an indication of the termination of authorization of the application program, the method further comprises:
unmarking the current process as authorized to deny further access by the process to the secured data.

52. The carrier medium of claim 43, wherein, if an intercepted file system operation originated from an application program comprising executable program code stored within the secured data, the method further comprises inhibiting writing to the secured data by the application program.

53. The carrier medium of claim 43, wherein, if the file system operation comprises a request to access an executable file, the method further comprises:
constructing an open file handle that identifies the executable file; and
returning the open file handle to the application program.

54. The carrier medium of claim 43, wherein, if the file system operation includes a request to open secured data that does not include an executable file, the method further comprises:
determining if a current process is marked as authorized such that the current process can further access the secured data.

55. The carrier medium of claim 54, wherein the method further comprises inhibiting opening of the secured data if the current process is not marked as authorized.

56. The carrier medium of claim 54, wherein, if the current process is marked as authorized, the method further comprises:
constructing an open file handle that identifies the secured data; and
returning the open file handle to the application program.
